(19) United States
(12) Patent Application Publication
(10) Pub. No.: US 2006/0163433 A1
(43) Pub. Date: Jul. 27, 2006

(54) Lighter than air kite

(76) Inventors: William J. Beckingham, Sterling, CO (US); Christopher W. Schiller, Crook, CO (US)

Correspondence Address: William J. Beckingham, 323 Chestnut Street, Sterling, CO, 80751, US

(21) Appl. No.: 11/334,108

(22) Filed: Jan. 17, 2006

Related U.S. Application Data
(60) Provisional application No. 60/645,126, filed on Jan. 21, 2005.

(51) Int. Cl. B64C 31/06

(52) U.S. Cl. 244/153 R

(57) ABSTRACT

An inflatable lighter than air kite that utilizes integrated negatively buoyant airfoils to provide positive orientation and aerodynamics, which automatically rights itself and remains aloft regardless of the presence of wind or manual control.

### CROSS-REFERENCE TO RELATED APPLICATIONS

This application claims benefit under 35 U.S.C. 119(e) of U.S. Provisional Patent Application No. 60/645,126, filed Jan. 21, 2005.

### BACKGROUND OF THE INVENTION

The present invention relates to a lighter than air inflatable kite exhibiting characteristics of both air driven kites and lighter than air balloons.

The use of airborne devices for the purposes of amusement, advertising, hunting and many other applications exist in prior art.

Prior art kites are dependent on wind conditions to effectively operate and fail to remain airborne in the absence of a critical level of wind. In addition, air driven kites require a level of manual control to operate properly. U.S. Pat. No. 4,029,273 and U.S. Pat. No. 5,762,293 both disclose inflatable kites exhibiting aerodynamic qualities but do not feature any lighter than air attributes required for use in still conditions.

Prior art lighter than air balloon designs lack the aerodynamic ability to remain aloft in windy conditions. U.S. Pat. No. 6,499,695 discloses a balloon kite which when filled with lighter than air gas will achieve lighter than air buoyancy but lacks air foils which are critical to aerodynamic stability and lift when flown in windy conditions.

U.S. Pat. No. 6,016,998 discloses a device in which a kite is attached with tape to a helium balloon. While this design addresses the issues of lighter than air buoyancy and wind aerodynamics it features a two piece construction requiring the attachment of separate kite and balloon elements.

There exists the need for a device that will effectively remain airborne and operate independent of optimal weather conditions or manual control. Such a device should include aerodynamic qualities enabling it to be flown like a kite in windy conditions, sufficient lighter than air buoyancy for use in still conditions, and be capable of structural design modifications incorporating these attributes that allow the device to resemble desirous objects for use in a variety of applications.

### BRIEF SUMMARY OF THE INVENTION

The invention consists of an inflatable kite comprised of a non-latex balloon constructed of two sheets of metallized nylon or other lightweight material heat-sealed or bonded together using standard balloon manufacturing processes and containing a self sealing inflation and deflation valve, an inflation chamber containing a sufficient volume of lighter than air gas to achieve buoyancy, integrated inflated or non-inflated airfoils used to weight the kite's lower peripheral edge enabling proper orientation to achieve lift and other aerodynamic flight characteristics common to kites, and a means for securing a flight line or tether to the kite body. Such means could include a pressure sensitive adhesive attachment applied to the kite body, string attachment tabs or apertures integrated in the peripheral seal of the balloon, or a harness type system.

In addition to the lighter than air kite's physical characteristics and their effects, during periods of intermittent or inconsistent wind which typically cause a kite to flip, roll, or lose altitude, the negatively buoyant airfoils counterbalance the positively buoyant inflation chamber allowing the lighter than air kite to right itself and maintain the proper orientation for positive lift kite flight. The combination of these qualities enable the lighter than air kite to right itself and remain aloft by flying like a kite in windy conditions, and floating like a helium balloon in still conditions.

It is an object and advantage that these attributes allow the lighter than air kite to be used effectively by persons unskilled in the art of kite flying.

It is a further object and advantage that the flight line or tether can be attached to a stationary object and the lighter than air kite will remain aloft unattended.

Embodiments of the invention would be structurally designed and graphically decorated to resemble game birds in flight for use as a hunting decoy, or be structurally designed and graphically decorated to resemble various desirable objects for use in amusement, advertising, or promotional applications.

### BRIEF DESCRIPTION OF THE SEVERAL VIEWS OF THE DRAWINGS

FIG. 1 is a perspective view of an inflated lighter than air kite's bird shaped embodiment in flight using an adhesive attachment.

FIG. 2 is a plan view of the lighter than air kite's bird shaped embodiment.

FIG. 3 is a perspective view of an inflated lighter than air kite's bird shaped embodiment in flight using string attachment tabs or apertures integrated in the peripheral seal of the balloon.

FIG. 4 is a plan view of the lighter than air kite's bird shaped embodiment with string attachment tabs or apertures integrated in the peripheral seal of the balloon.

FIG. 5 is a perspective view of an inflated lighter than air kite's bird shaped embodiment in flight using a harness type system.

FIG. 6 is a perspective view of an inflated alternately shaped second embodiment of the lighter than air kite in flight using an adhesive attachment.

FIG. 7 is a plan view of the alternately shaped second embodiment of the lighter than air kite of FIG. 6.

FIG. 8 is a perspective view of an inflated alternately shaped second embodiment of the lighter than air kite in flight using an adhesive attachment and featuring inflated airfoils.

FIG. 9 is a plan view of the alternately shaped second embodiment of the lighter than air kite of FIG. 8 featuring inflated airfoils.

FIG. 10 is a perspective view of an inflated alternately shaped third embodiment of the lighter than air kite in flight using an adhesive attachment.

FIG. 11 is a plan view of the alternately shaped third embodiment of the lighter than air kite of FIG. 10.

### DETAILED DESCRIPTION OF THE INVENTION

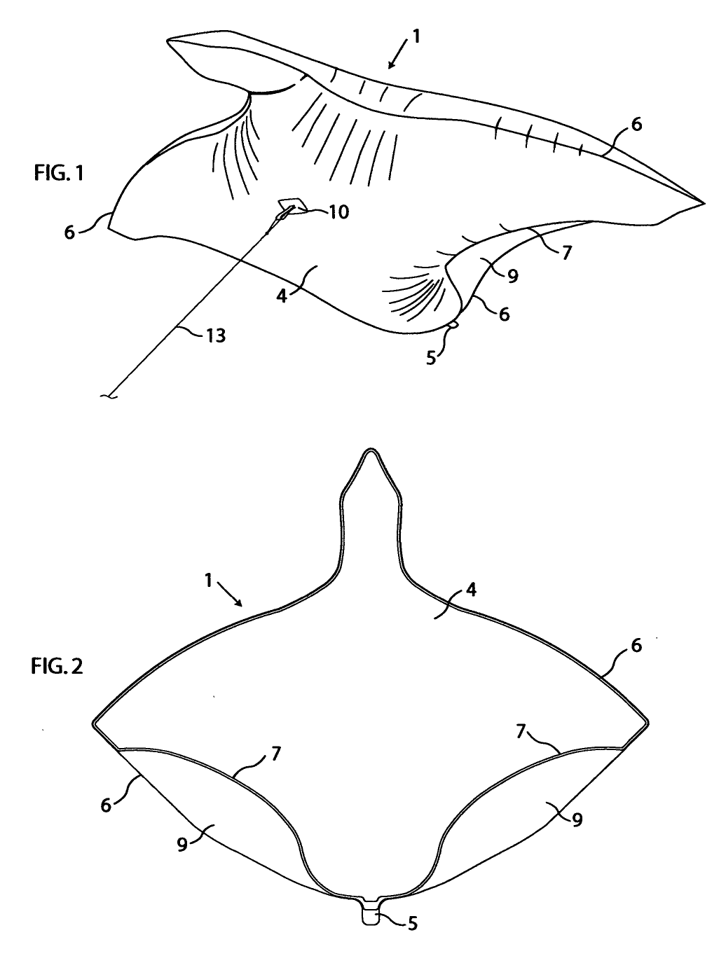

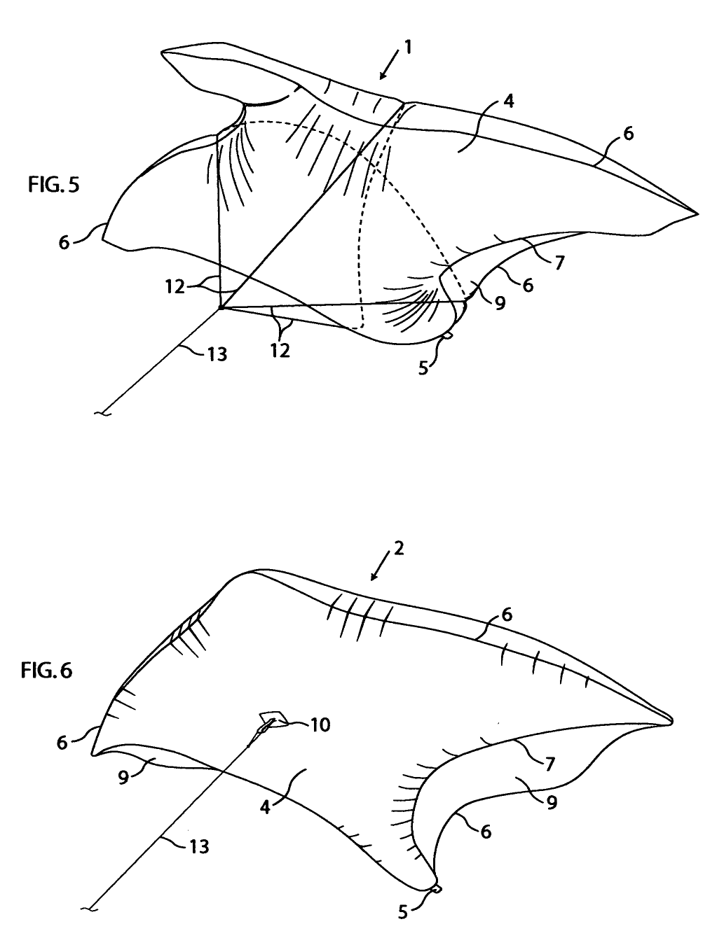

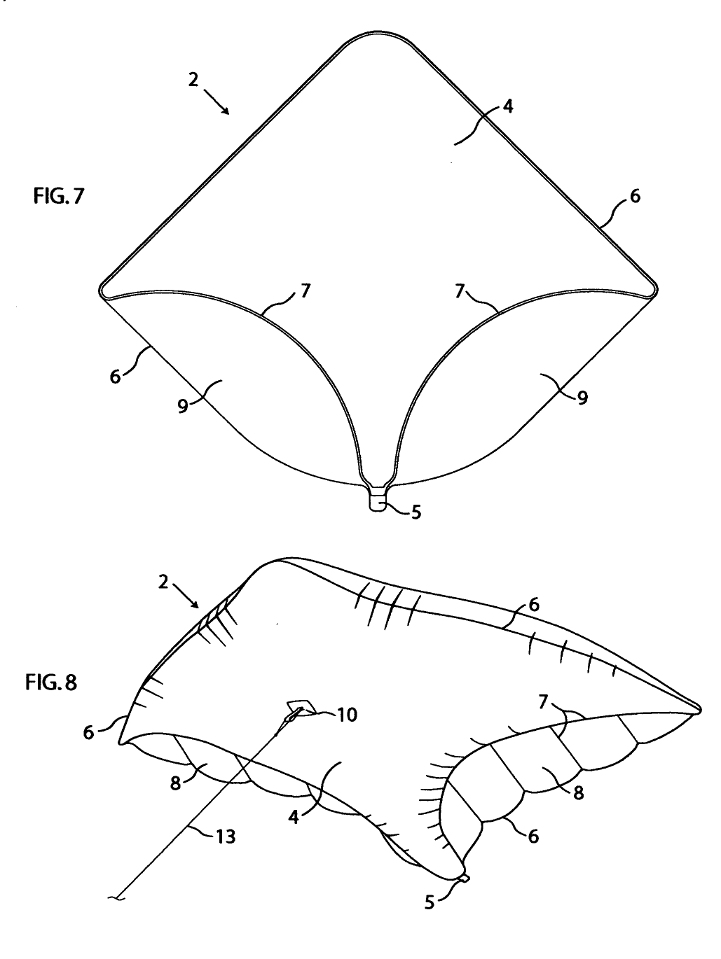

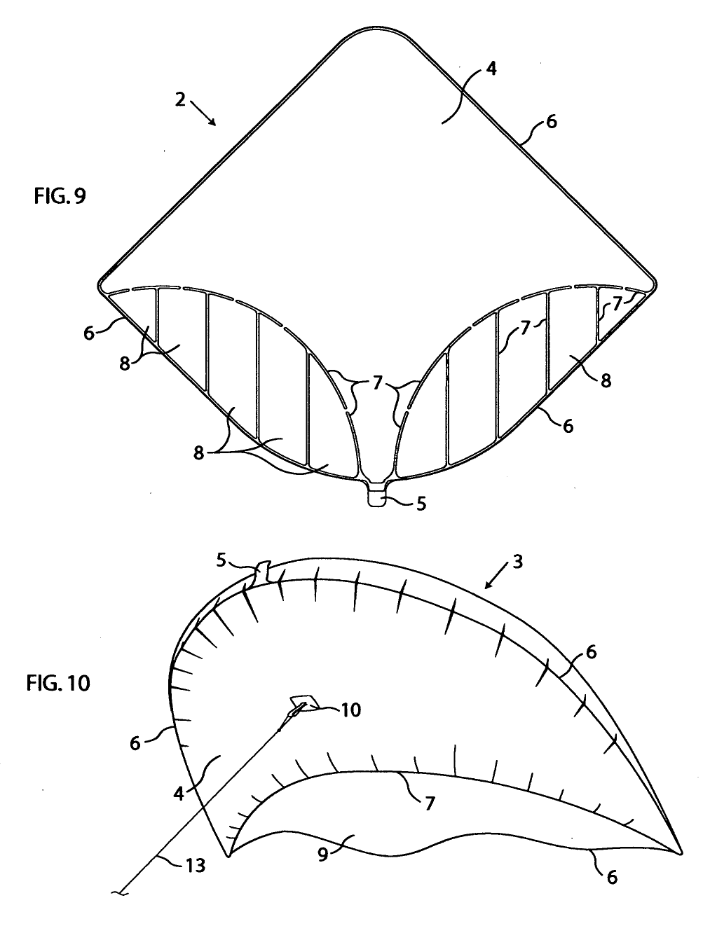

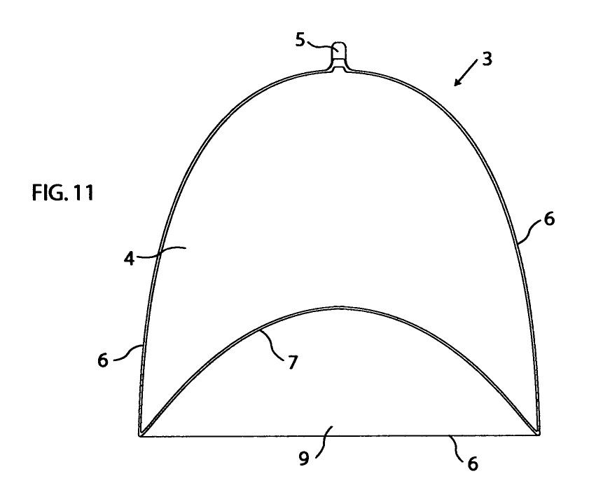

The lighter than air kite, first exampled in a bird shaped embodiment 1 in FIGS. 1-5 and further exampled in alternately shaped second embodiment 2 FIGS. 6-9, and alternately shaped third embodiment 3 in FIGS. 10-11, is comprised of a non-latex balloon formed or constructed by heat-sealing or bonding together two sheets of metallized nylon or other acceptable lightweight material by the conventionally known means of standard non-latex balloon manufacturing processes. Such balloons are typically manufactured to include in their structure and assembly a self-sealing inflation and deflation valve 5 used as an aperture to inflate the balloon, retain sufficient air pressure to maintain the balloons shape, and, when de-activated, allow the air or lighter than air gas to escape the inflation chamber 4 so that the balloon may be deflated and used again.

The inflation chamber 4 formed by the peripheral seals 6 and interior seals 7 is large enough to contain a sufficient interior volume of lighter than air gas or helium for the balloon to overcome the gravitational weight of the material from which it is manufactured, the integrated airfoils 8 or 9, the attachment mechanism 10, 11 or 12, and the flight line or tether 13, to achieve positive atmospheric buoyancy and allow the lighter than air kite to maintain an aloft position in the absence of wind.

The presence of wind will cause a typical lighter than air balloon to lose altitude, flutter, spin, or otherwise become erratic. Using peripheral seals 6 and interior seals 7 to incorporate either inflated airfoils 8 or non-inflated airfoils 9 in the design and manufacture of the lighter than air kite provides an aerodynamic surface to direct or channel the kinetic force of wind to enable lift, stability, and other flight characteristics common to kites. Additionally, intermittent or inconsistent wind will typically cause a kite to occasionally flip, roll, or lose altitude. The negatively buoyant airfoils 8 or 9 weight the lower peripheral edge of the kite, counterbalance the positively buoyant inflation chamber 4, and cause the lighter than air kite to right itself to regain and maintain the proper orientation for positive lift kite flight.

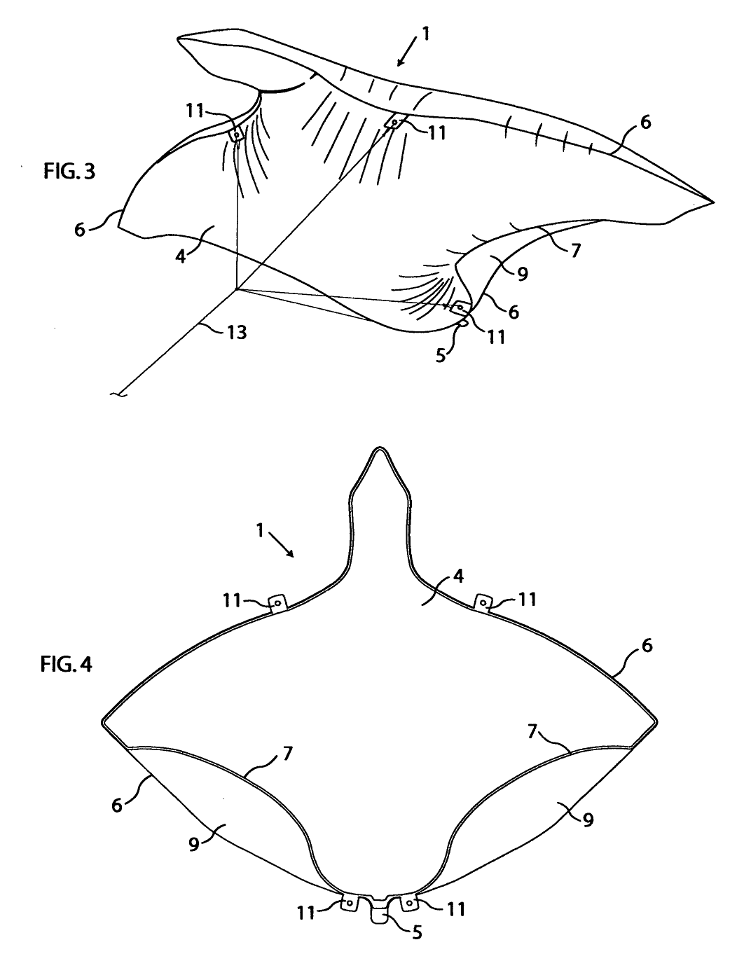

The lighter than air characteristics of the invention require means to prohibit the lighter than air kite from irretrievably escaping into the atmosphere. This includes a flight line or tether 13 to be manually held and controlled or secured to a stationary object to allow the lighter than air kite to be deployed at the desired altitude, and means to attach or secure the flight line to the body of the lighter than air kite. Such means are illustrated to include a pressure sensitive adhesive attachment 10 including a string, ribbon, aperture, or other means for securing the flight line or tether 13 applied to the kite body FIGS. 1,6,8, and 10, string attachment tabs or apertures 11 for securing the flight line or tether 13 integrated in the peripheral seal 6 of the balloon FIG. 3, or a harness type system 12 to restrain the lighter than air kite secured to the flight line or tether 13, FIG. 5.

The lighter than air kite and its combined attributes described herein permit the kite to automatically right itself, float like a helium balloon in still conditions, and fly like a kite when conditions of wind prevail. Advantages to the combination of characteristics enabling the lighter than air kite to remain aloft regardless of wind conditions or skill level include effective use by persons unskilled in the art of kite flying and effective untended use in situations where manual control is unnecessary or undesired.

In practical application the bird shaped embodiment 1 is structurally designed and graphically decorated to resemble game birds in flight for use as a hunting decoy. The bird shaped embodiment 1 of the lighter than air kite can be deployed over a traditional decoy spread at the desired altitude by securing the flight line or tether 13 to a stationary object such as a stake or weight, or by retaining the flight line or tether 13 for manual control. As the bird shaped embodiment 1 of the lighter than air kite imitates game birds in flight, live game birds are attracted to the hunting site to be harvested by conventional means.

Further applications of embodiments of the lighter than air kite include structurally designing and graphically decorating the lighter than air kite to resemble various desirable objects for appeal and use as an amusement device, or for use in advertising and promotional situations.

Descriptions of the invention in several embodiments have been made for the purpose of illustration and not to limit the invention to the embodiments described within. It is to be understood that modifications, alterations, and changes to various details of the invention can be made without departing from the true scope and spirit of the present invention.

What is claimed is:

1. A lighter than air kite formed of two sheets of metallized nylon or other lightweight material heat-sealed or bonded together using standard non-latex balloon manufacturing methods and including an integrated self sealing inflation valve.

2. The lighter than air kite of claim 1, wherein the peripheral and interior seals form an inflation chamber to contain a sufficient volume of lighter than air gas to achieve buoyancy.

3. The lighter than air kite of claim 1, wherein the peripheral and interior seals form one or more integrated inflated or non-inflated airfoils for the purpose of:
a) providing aerodynamic surfaces to achieve lift and other aerodynamic flight characteristics common to kites and,
b) weighting the kite's lower peripheral edge to counterbalance the positively buoyant inflation chamber allowing the lighter than air kite to right itself and maintain the proper orientation for positive lift kite flight.

4. The lighter than air kite of claim 1, including a means for securing a flight line or tether to the kite body comprising:
a) a pressure sensitive adhesive attachment applied to the kite body, or
b) string attachment tabs or apertures integrated in the peripheral seal of the balloon, or
c) a harness type system.

5. The lighter than air kite of claim 1, wherein the lighter than air kite is structurally designed and graphically decorated to:
a) resemble game birds in flight for use as a hunting decoy, or
b) resemble various desirable objects for use in amusement, advertising, or promotional applications.
